(19) United States
(12) Patent Application Publication
(10) Pub. No.: US 2026/0274632 A1
(43) Pub. Date: Sep. 17, 2026

(54) METHOD FOR LOADING AND/OR UNLOADING A LOADING SPACE USING AN AUTONOMOUS LOADING VEHICLE AND SAFEGUARDING SYSTEM

(71) Applicant: SICK AG, Waldkirch (DE)

(72) Inventor: Mathias AMS, Denzlingen (DE)

(21) Appl. No.: 19/566,159

(22) Filed: Mar. 13, 2026

(30) Foreign Application Priority Data
Mar. 17, 2025 (EP) 25164169.2

(51) Int. Cl. B66F 17/00; B65G 67/02; B66F 9/06

(52) U.S. Cl. CPC B66F 17/003; B66F 9/063; B65G 67/02; B65G 2814/0302; B65G 2814/0352

(57) ABSTRACT

An embodiment relates to a method for loading and/or unloading a loading space, in particular the loading space of a transport vehicle, using an autonomous loading vehicle that drives into the loading space at least once in order to pick up and/or place at least one load object. In this respect, an access zone of the loading space is safeguarded by a stationary sensor device arranged at the access zone. The loading vehicle is safeguarded by a mobile sensor arrangement arranged at the loading vehicle. The stationary sensor device and the mobile sensor arrangement communicate with one another. Before a driving into the loading space, the loading vehicle is uniquely identified by the stationary sensor device using an identification sensor included by the stationary sensor device and at least a first piece of identity information provided by the mobile sensor arrangement.

The invention relates to a method for loading and/or unloading a loading space, in particular the loading space of a transport vehicle, using an autonomous loading vehicle and to a safeguarding system for safeguarding the loading and/or unloading of a loading space, in particular the loading space of a transport vehicle, using an autonomous vehicle according to the preamble of the independent claims.

The loading and unloading of a transport vehicle, for example a truck, in particular its trailer, at a loading dock, which is referred to as truck loading, has so far taken place manually using manned or person-driven forklift trucks. In this respect, it is the responsibility of the forklift operator or an operator to watch out for persons and to avoid accidents. Autonomous vehicles, so-called Automated Guided Vehicles (AGVs), are indeed already being used in the logistics sector that would in principle be capable of taking over the truck loading or at least enabling a mixed operation between a manual operation and a fully automated operation. However, there is no solution for ensuring that no person is located in the trailer, or on the path thereto, during the loading and unloading process. In other automated logistics applications, autonomous vehicles only work in zones closed off for persons. However, this cannot be implemented at a loading dock.

Autonomous vehicles already monitor their journey with sensors, which are attached to the respective AGVs, to prevent accidents. In this respect, a protective field is, for example, produced or monitored in the direction of travel of the AGV. If an object is recognized in the protective field, a hazardous situation is assumed and the AGV is braked or stopped completely. Electrosensitive protective equipment that is based on a corresponding sensor is used for this purpose. The entry of an object or a person, in particular a body part of a person, into a protective field is detected with the aid of one or more corresponding sensors without a direct mechanical contact taking place. Corresponding sensors are based on different physical principles. For example, optical sensors, acoustic sensors, such as ultrasonic sensors, inductive or capacitive sensors and radar sensors are used. Sensors that are used to avoid accidents have to work reliably and must therefore satisfy high safety demands, for example the standard IEN SO 13849 for safety of machinery and the machinery standard EN/IEC 61496 for electrosensitive protective equipment (ESPE). To satisfy these safety standards, a series of measures have to be taken such as the safe electronic evaluation by redundant, diverse electronics, functional monitoring or monitoring of the contamination of optical components.

Conventional protective field monitoring, however, does not work in a trailer. The load is packed very tightly and without empty spaces for economic reasons. In the case of protective field monitoring, it is typically only determined whether the protective field is free of objects. This would as good as never be the case within the trailer so that the vehicle practically no longer comes out of standstill. There have been approaches to differentiate between permitted and unpermitted objects in a protective field; however, in particular under said tight storage conditions, today's sensor systems are not able to reliably distinguish between persons and cargo.

An object of the invention consequently comprises specifying a safe solution for the automated loading and unloading of the loading space, in particular the loading space of a transport vehicle, i.e. the loading and unloading of the loading space using at least one autonomous vehicle.

The object is satisfied by the method and the safeguarding system of the independent claims. Further developments and embodiments of the invention are the subject of the dependent claims in each case.

One embodiment of the invention relates to a method for loading and/or unloading a loading space, in particular the loading space of a transport vehicle, using an autonomous loading vehicle that drives into the loading space at least once in order to pick up and/or place at least one load object. An access zone of the loading space is safeguarded by a stationary sensor device arranged at the access zone. The loading vehicle is safeguarded by a mobile sensor arrangement arranged at the loading vehicle. The stationary sensor device and the mobile sensor arrangement communicate with one another. Before a driving into the loading space, the loading vehicle is uniquely identified by the stationary sensor device using an identification sensor included by the stationary sensor device and at least a first piece of identity information provided by the mobile sensor arrangement.

The solution according to the invention provides for the autonomous loading vehicle to be uniquely identified before driving into the loading space. This means that the identification of the autonomous loading vehicle is functionally safe. It is thereby ensured that only a properly identified loading vehicle may enter the loading space for the loading and/or unloading. At the same time, it is ensured that no other person or object can pass through the access zone. Thus, an automated loading and unloading of the loading space is made possible in a safe manner.

A loading space is, for example, a region which is closed by walls, and is thus only accessible through the access zone, and in which products or other objects called load objects are stored, preferably for a transport as in the case of a container, a semi-trailer, or a trailer. For this purpose, a loading vehicle drives into the loading space at least once, as a rule repeatedly multiple times, to place and/or pick up at least one load object. The loading vehicle is preferably an autonomous vehicle such as an AGV or an autonomous mobile robot (AMR). The loading vehicle can alternatively still be operated by a driver. The driver is then automatically safeguarded by the invention from possible accidents with persons or other objects in his work zone.

The access zone that represents the only possibility of accessing the loading space is safeguarded by the stationary transmission device. For example, the stationary sensor device is configured to recognize access by objects and to implement the safety function “access safeguarding”, in particular “optical access safeguarding”. When an object is detected, a corresponding measure is triggered. In this way, the access zone is so-to-say safeguarded against the entry by objects. The loading vehicle itself is safeguarded by the mobile sensor arrangement. The stationary sensor device and the mobile sensor device together ensure, using the communication, that the loading vehicle does not collide with unexpected objects during the loading and unloading, and in particular that accidents with personal injury are avoided. During the communication, for example, data, information and/or control signals are exchanged between the stationary sensor device and the mobile sensor arrangement.

In addition to the identification sensor according to the invention, the stationary sensor device comprises at least one further sensor that safeguards the access zone in a known manner. This sensor can, for example, be designed as an optical sensor, such as a camera, a laser scanner or a light grid, and preferably recognizes the presence of an object in the access zone. Apart from the exceptional situation of the safely identified loading vehicle in the access zone, said access zone is impermeable; in any case, objects cannot enter unnoticed.

The identification sensor is a further sensor that is arranged at the access zone and that, in conjunction with the identity information provided by the mobile sensor arrangement, enables a unique identification of the loading vehicle. In particular, the first piece of identity information has a safety mechanism. The identification sensor can be used as a reading device for a radio frequency identification (RFID), as an optical reading device for codes such as barcodes or QR codes, or as a base station for short-range radio communication, for example Ultra Wide Band, in particular as a UWB anchor, depending on the application. The identity information provided by the mobile sensor arrangement is matched to the identification sensor.

The loading vehicle is safeguarded by the mobile sensor arrangement. For this purpose, the mobile sensor arrangement comprises at least one sensor, for example a laser scanner, that implements the “collision avoidance” safety function at least outside the loading space. Thus, it is ensured outside the loading space that no objects or persons come into direct contact with the autonomous loading vehicle, AGV or AMR. Safety distances are maintained and hazards for persons are ruled out.

The invention advantageously enables an automated loading and unloading that considers the safety aspects. Unlike previous approaches, it is in this respect no longer necessary to block the entire activity zone of the loading vehicle for persons. Consequently, persons may by all means remain in the environment of the loading vehicle and can also intervene in good time in the event of impending malfunctions or carry out supplementary work steps without accidents occurring.

According to a further development, a point in time at which the loading vehicle is uniquely identified is determined using a first reliable position determination.

So that the unique identification of the loading vehicle leads to the desired functional safety, or enables the desired functional safety, it is important to find the right time for this identification when an AGV approaches the access zone or loading space. Any danger to persons or the driving of an unauthorized, i.e. unidentified, AGV into the loading space should be ruled out at all times. According to the invention, this point in time is determined with the aid of the first reliable position determination.

According to a further development, the first safe position determination comprises at least one of the following steps:
detecting a distance of the loading vehicle from the access zone by means of the stationary sensor device,
determining a position of the loading vehicle by means of its mobile sensor arrangement and transmitting this position to the stationary sensor device, validating the transmitted position of the loading vehicle with the detected distance by means of the stationary sensor device, in particular using a tracking algorithm, and
if the validated position corresponds to a predefined first position, starting the unique identification of the loading vehicle by the stationary sensor device, wherein the predefined first position is located so close to the access zone that no person fits between the loading vehicle and the access zone.

In the first safe position determination, the position of the autonomous loading vehicle is therefore determined twice, namely once by the mobile sensor arrangement and a second time by the stationary sensor device. In this respect, the position of the AGV is in each case determined in relation to the non-variable position of the stationary sensor arrangement that is attached to the access zone. The current distance of the loading vehicle is determined using at least one sensor of the stationary sensor device, for example a camera or a laser scanner. In addition, the loading vehicle itself determines its position and communicates this to the stationary sensor device. A validation takes place there, i.e. it is checked whether the transmitted position matches the determined distance as far as possible. If these steps are carried out multiple times, i.e. if the loading vehicle determines its position multiple times while approaching the access zone and the stationary sensor device also detects the distance of the same loading vehicle multiple times, a so-called tracking algorithm can also be used in the validation and enables a tracking of the route of the loading vehicle. If there is a high degree of agreement, a validated position exists. If the validated position corresponds to the predefined first position, i.e. is so close to the access zone that no person fits between the loading vehicle and the safeguarded access zone, the unique identification of the loading vehicle described above is triggered.

In an exemplary implementation, such a tracking algorithm is based on an object detection algorithm. The latter works according to the principle of background subtraction, for example. When setting up the stationary sensor device, the background is in this respect recorded without objects and then serves as a reference. During ongoing operation, an image in the form of a depth map is generated for each recording by a camera of the stationary sensor device, for example a so-called time-of-flight (TOF) camera, of an object that passes under or approaches the sensor device. The reference and the depth map of the recorded objects are algorithmically subtracted so that the image of the object remains as a result in the form of contiguous pixels. The contiguous pixels are grouped to identify contiguous structures. The contiguous structures are classified with reference to their volume, for example. The features for the classification are defined in advance by means of configuration. For example, there are different classes for registered vehicles. The contiguous structures are measured. For the image currently captured by the TOF camera, the contiguous structures are stored as objects with further attributes such as geometric dimension, classification, position, correlation interval, time stamp, etc. in a camera imaging data structure. The described classification and storage of the contiguous structures may be repeated under certain circumstances until all contiguous structures of a recorded image have been classified and measured. The algorithm works with a further data structure in which the tracking data are stored. The tracking data of all the objects located in the detection zone of the static sensor device are stored in this tracking data structure. In the tracking data structure, the object ID, classification and geometric dimensions are stored once for each object and the position, the velocity vector and the time stamp are stored once for each imaging interval. With each new image, the objects from the camera imaging data structure are compared with the tracking data structure. If a clear correlation between an object already stored in the tracking data structure and the camera imaging data structure results, this object is assigned to the existing track. A clear correlation is, for example, given if the following conditions are met:
a) The last position stored in the tracking data structure summed with a velocity vector, which is multiplied by a delta related to the timestamp, lies in the correlation interval of the object from the camera imaging data structure,
b) The geometric dimensions of the object from the tracking data structure match the geometric dimensions of the object from the camera imaging data structure, wherein a transformation with respect to the perspective is considered.

With the assignment to an existing track, the following values are stored, updated or extended in the tracking data structure: position, velocity vector, timestamp. If an object from the camera imaging data structure cannot be assigned to an object from the tracking data structure, a new object is created in the tracking data structure, provided that the following validation criterion is met: The position of the object is realistic, i.e. it is possible to cover the distance from outside the detection zone back to the current detection position within one detection interval of the stationary sensor device.

The first position is oriented to anthropometric dimensions, wherein, in the cross-sectional dimensions of relevance here, a body is typically in each case larger than, for example, 20 cm, 30 cm, 50 cm, or 70 cm.

By using the unique identification of the autonomous loading vehicle in conjunction with the reliable positioning, it becomes possible to fully automate the loading and unloading of the loading space while ensuring the functional safety. Thus, the operation of logistics centers can, for example, also be optimized in an economic respect.

In a further embodiment, the determination of the position of the loading vehicle by its mobile sensor arrangement takes place using a localization system that is based on one or more of the following measures: a map stored in the mobile sensor arrangement, a recognition of optical or physical markers that are attached in the access zone, an indoor navigation.

Accordingly, the loading vehicle or the mobile sensor arrangement has a localization system that can be implemented in a control and evaluation unit of the mobile sensor arrangement. For example, the loading dock is stored on a map as a safety-relevant position in said control and evaluation unit. For example, as soon as the localization system recognizes that the loading vehicle is located in this safety-relevant region of the loading dock, this position is transmitted to the stationary sensor arrangement. Alternatively or additionally, the localization system of the autonomous loading vehicle can in a customary manner also be based on the recognition of optical or physical markers in the access zone. An indoor navigation method can also be used for this purpose, for example, based on Bluetooth Low Energy, WLAN or UWB.

According to a further development, the following steps are carried out when uniquely identifying the loading vehicle:
contactlessly reading the first piece of identity information provided by the mobile sensor arrangement by means of the identity sensor of the stationary sensor device,
checking the first piece of identity information by means of the stationary sensor device using a stored identity and a second piece of identity information that is transmitted by the mobile sensor device and that is different from the first piece of identity information.

At least the first piece of identity information is used for the unique identification or identification of the loading vehicle. It is checked by the stationary sensor device. In this respect, a comparison of the transmitted information with the stored identity takes place, for example. In addition, if the first piece of identity information does not have a safety mechanism, a second piece of identity information transmitted by the mobile sensor arrangement is used. It is transmitted via a different route, for example, and differs from the first piece of identity information, for example, with respect to the source. If the identity stored for the first piece of identity information matches an identity stored for the second piece of identity information, the loading vehicle is uniquely identified. This identification process can also be designated as authentication.

In a further development, the contactless reading of the first piece of identity information provided by the mobile sensor arrangement takes place using one of the following means: radio frequency identification (RFID), optical readout, short-range radio communication, for example UWB. Accordingly, the provided first piece of identity information comprises one of the following: a radio frequency identification transponder ID, a barcode, a QR code, a short-range radio communication transponder ID, for example a UWB transponder ID.

Suitable for the identity sensor of the stationary sensor device, the reading of the first piece of identity information takes place contactlessly using one of the alternatives listed above. A transponder can also be called the tag or radio tag. Each transponder is assigned a unique identity, i.e. an ID.

In a further development, the transmission of the second piece of identity information of the mobile sensor arrangement to the stationary sensor device takes place via a wireless communication device, in particular a wireless local area network, in particular a WLAN. Accordingly, the second piece of identity information is a device identifier, in particular a Medium Access Control (MAC) address, or an application-specific identifier.

In an exemplary implementation, the second piece of identity information can be sent via the WLAN, which is also used for the communication between the mobile sensor arrangement and the stationary sensor device, for example as part of a registration of the loading vehicle at the stationary sensor device. The device identifier is known to be unique. This device identifier can thus be used in a simple manner when checking the first piece of identity information as described above. The application-specific identifier is an identifier or address that refers to the application layer of the OSI reference model.

In a further development, after a successful unique identification of the loading vehicle, the safeguarding of the access zone by the stationary sensor device is adjusted such that a drive-through corridor is provided for a driving of the loading vehicle into the loading space. Furthermore, the safeguarding of the mobile sensor arrangement is deactivated almost at the same time. The drive-through corridor is closed as soon as the loading vehicle has passed through the access zone. From this point in time, the stationary sensor device safeguards the access zone by recognizing access by an object.

According to the invention, the stationary sensor device decides whether a loading vehicle that wants to drive into the loading space may pass. If the loading vehicle has been successfully identified as described and the loading vehicle is in the correct position in front of the stationary sensor device, the decision is positive and the drive-through corridor for the loading vehicle is provided. Due to a corresponding signal from the stationary sensor device to the mobile sensor arrangement, the mobile sensor arrangement is caused to switch off its safeguarding, which ensures a collision avoidance. The loading vehicle is then instructed to drive on. A partial muting of the access safeguarding, for example the optical access safeguarding, takes place in the stationary sensor device when providing the drive-through corridor. Partial in this respect refers to a zone that is enclosed by the access zone and that is adapted in size to the dimensions of the loading vehicle, in particular its width. Thus, the muting is designed so tightly that no persons fit between the loading vehicle and the safeguarding of the stationary sensor device. The part of the access zone that is not muted and that lies outside the drive-through corridor also continues to be safeguarded by the stationary sensor device while the loading vehicle is driving through. Consequently, no person can enter the drive-through corridor unnoticed or can enter the loading space unnoticed next to the loading vehicle during the driving through by the latter. As soon as the loading vehicle has passed through the access zone completely, i.e. in its full length, and is thus located in the loading space, the partial muting is ended and the drive-through corridor is closed again. The loading vehicle can now place or pick up one or more load objects. Since the collision avoidance function of the mobile sensor arrangement is switched off, the loading vehicle can also move unhindered in the confined environment of the loading space.

In a further development, a communication between the stationary sensor device and the mobile sensor arrangement takes place using the above-described wireless communication device that is in particular implemented as a wireless local area network, for example as WLAN.

A standard wireless network is used for the communication between the loading vehicle and the stationary sensor device, in particular in conjunction with appropriate communication protocols such as TCP/IP. To safeguard the communication even further and to ensure the reliability, known secure protocols such as Enhanced Function Interface, EFI-pro can be used. The wireless communication connection between the loading vehicle or its mobile sensor arrangement and the stationary sensor device is established, for example, when the loading vehicle approaches the access zone. In the stationary sensor device, an access point is provided as a communication interface for this purpose, while the mobile sensor arrangement comprises a matching client as a communication interface. Alternatively, the communication can take place via Bluetooth or a mobile radio connection according to 3G/4G/5G.

In a further embodiment, on a driving of the loading vehicle out of the loading space, a point in time at which the stationary sensor device provides a drive-through corridor for the passing through of the access zone by the loading vehicle is determined using a second safe position determination. The drive-through corridor is provided by adjusting the safeguarding by the stationary sensor device and is closed again as soon as the loading vehicle has passed through the access zone. From this point in time, the stationary sensor device safeguards the access zone by recognizing access by an object. The mobile sensor arrangement likewise again safeguards the loading vehicle against collision from this point in time.

On the driving out of the loading vehicle, the point in time at which the drive-through corridor is opened for the loading vehicle is determined using the second safe position determination. In this respect, it is irrelevant whether the loading vehicle has turned in the loading space or not, i.e. whether it drives forwards or backwards out of the loading space. The identity of the vehicle is already present in the stationary sensor device. The drive-through corridor is provided in a similar way to that described above. As soon as the loading vehicle has driven completely out of the loading space, i.e. in its full length, and has completely passed through the access zone, the safeguarding of the access zone by the stationary sensor device is activated again across the entire width of the access zone and the mobile sensor arrangement activates the safeguarding of the loading vehicle against collision. Optionally, as soon as the loading vehicle has arrived outside the loading space, but is still close enough to the access zone that no person fits between the loading vehicle and the access zone, it can stop for safety reasons and only then continues its journey.

In a further development, the second safe position determination comprises at least one running through of the following steps:
detecting a distance of the loading vehicle from the access zone by means of the stationary sensor device,
determining a position of the loading vehicle by means of its mobile sensor arrangement and transmitting this position to the stationary sensor device, validating the transmitted position of the loading vehicle with the detected distance by means of the stationary sensor device, in particular using a tracking algorithm, and
if the validated position corresponds to a predefined second position, providing the drive-through corridor,
wherein the predefined second position is located within the loading space so close to the access zone that no person fits between the loading vehicle and the access zone.

In a similar way as during the driving into the loading space, the position of the loading vehicle is also determined twice when driving out of the loading space, on the one hand, by measuring the distance, for example using an optical sensor such as a camera of the stationary sensor device, and, on the other hand, by the loading vehicle determining its own position. The results are checked in the stationary sensor unit. If the measurement results are valid, it is additionally tested whether the current position of the loading vehicle corresponds to the second predefined position. If the steps of the second safe position determination are run through multiple times, a tracking algorithm can optionally additionally be used that tracks and records the movement of the loading vehicle. As soon as the loading vehicle is in the required position, i.e. the second position, the drive-through corridor is opened.

According to a further development, the determination of the position of the loading vehicle by its mobile sensor arrangement takes place using its localization system.

The loading vehicle recognizes the reaching of the second predefined position, in particular using its localization system. Said localization system uses, as described, at least one sensor of the mobile sensor arrangement in the customary manner and is optionally additionally based on the use of a stored map.

According to a further development, when the presence of an object in the access zone is recognized by the stationary sensor device, a safety response of the loading vehicle is initiated, in particular when said loading vehicle is located between the first and the second predefined position. In this safety response, the vehicle is stopped, or the loading vehicle performs a compensating movement or reduces its speed.

The stationary sensor device recognizes the presence of an object in the access zone. The access zone is impermeable, i.e. objects or persons cannot enter unnoticed. The only exception to this is if the loading vehicle is located in the drive-through corridor and then only for the part of the access zone that forms the drive-through corridor. The mobile sensor arrangement recognizes the presence of an object in front of or next to the loading vehicle. Collisions during the travel of the loading vehicle are thereby avoided so that in particular objects in the direction of travel are of interest. Objects in other directions, for example laterally next to the loading vehicle, can additionally be detected in order to prevent accidents when the loading vehicle changes direction or to deal with situations where a person jumps in front of the loading vehicle from the side. When the presence of an object is recognized by the stationary sensor device, a safety response of the loading vehicle is brought about, in particular if said loading vehicle is located behind the first safety position in the direction of the second safety position, for example by transmitting a corresponding command via the communication connection. If the mobile sensor device has recognized an object, a possible danger is obvious. However, this safeguarding is only active outside the loading space. An object recognized by the stationary sensor device means that at least one object can be located in a region in which the loading vehicle is not prepared for it, in particular in the loading space. Therefore, according to the invention, the stationary sensor device triggers the safety response when the presence of an object is recognized, in particular when the loading vehicle is located behind the first safety position in the direction of travel with respect to the second safety position. Depending on the safety concept of an application, the loading vehicle can, for example, be stopped, can carry out an evasive movement, or can be decelerated to a safe slow speed of, for example, less than 0.3 m/s. The safety response can optionally be accompanied or announced by an optical or acoustic warning signal.

In one possible implementation, the method can be implemented as a computer-implemented method. For example, it runs in a computing unit of the mobile sensor arrangement and/or a computing unit of the stationary sensor device or in a computing unit of a higher-ranking system.

In one embodiment, a safeguarding system for safeguarding a loading and/or unloading of a loading space, in particular the loading space of a transport vehicle, using an autonomous loading vehicle, which drives into the loading space at least once in order to pick up and/or place at least one load object, has a stationary sensor device and a mobile sensor arrangement. The stationary sensor device is arranged at an access zone of the loading space and is configured to safeguard this access zone. It has at least a first sensor arranged at the access zone, an identification sensor and a communication interface for communicating with the mobile sensor arrangement. The mobile sensor arrangement is arranged at the loading vehicle and is configured to safeguard the loading vehicle. It is also configured to provide at least a first piece of identity information and has a second sensor. Furthermore, the mobile sensor arrangement comprises a communication interface for communicating with the stationary sensor device. The stationary sensor device is further configured to uniquely identify the loading vehicle before a driving into the loading space using the identification sensor and at least the first piece of identity information.

The safeguarding system according to the invention safeguards the loading and/or unloading of the loading space based on the stationary sensor device and the mobile sensor arrangement, among other things, by reliably identifying the loading vehicle before driving into the loading space. Only a safely identified loading vehicle is allowed to drive into the loading space. Access by persons or objects is reliably detected. Consequently, it is possible to perform the loading and unloading of the loading space completely by autonomous loading vehicles while maintaining the functional safety. In this respect, it is ensured at all times that an endangerment of persons is ruled out.

The method according to the invention described above is carried out, for example, in the safeguarding system or is implemented by it. Advantages and further developments apply accordingly.

In a further development of the safeguarding system, the first sensor and/or the second sensor is one of the following: a single layer laser scanner or a multilayer laser scanner, a LiDAR sensor, a 3D camera, in particular a time of flight camera, a radar sensor or a radio location system. The identification sensor is one of the following: a reading device for RFID, an optical scanner for barcodes or QR codes, or a base station for short-range radio communication, in particular a UWB anchor.

The invention will be explained in more detail in the following, also with respect to further features and advantages, by way of example with reference to embodiments and to the enclosed drawing. In this respect, the same elements have the same reference signs. The Figures of the drawing show in:

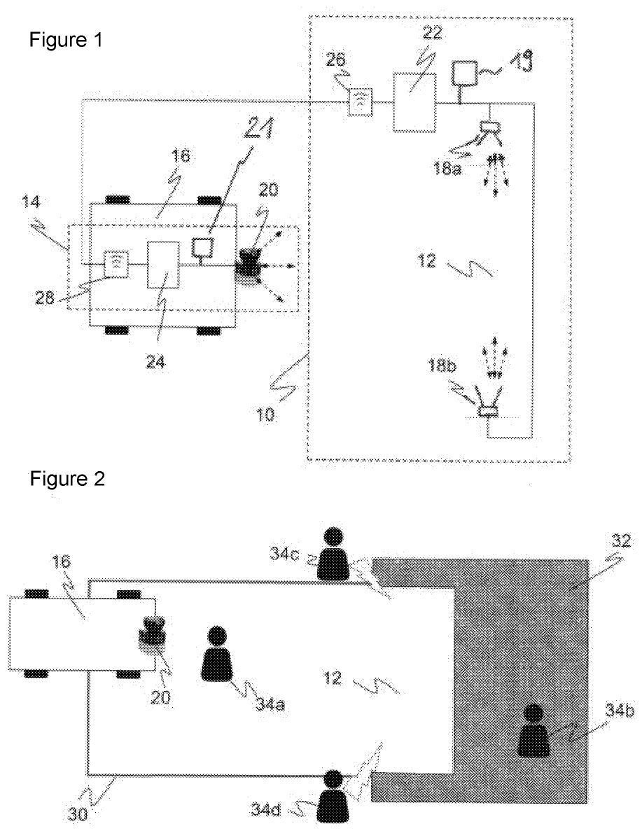

FIG. 1 a schematic overview representation of a safeguarding system as proposed;

FIG. 2 a schematic plan view of a loading zone with possible dangers to persons by a loading vehicle;

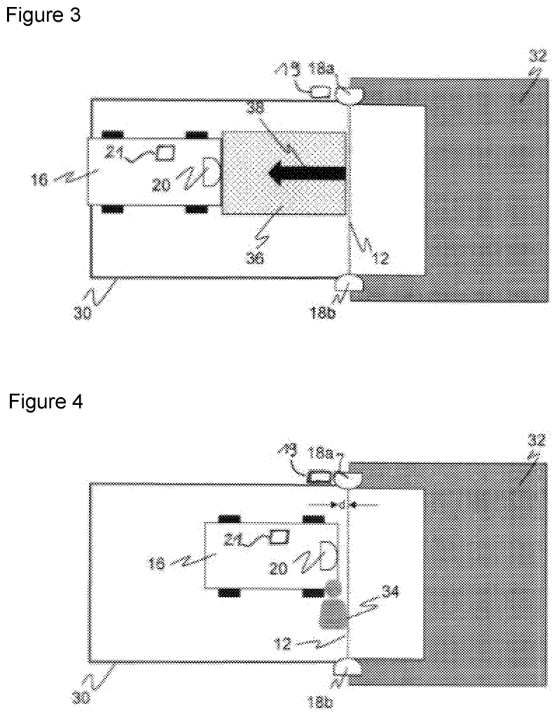

FIG. 3 a schematic plan view of a loading zone on an approach of a driving-in loading vehicle to a safeguarded access zone;

FIG. 4 a schematic plan view of the loading zone in which the driving-in loading vehicle has reached a first predefined position;

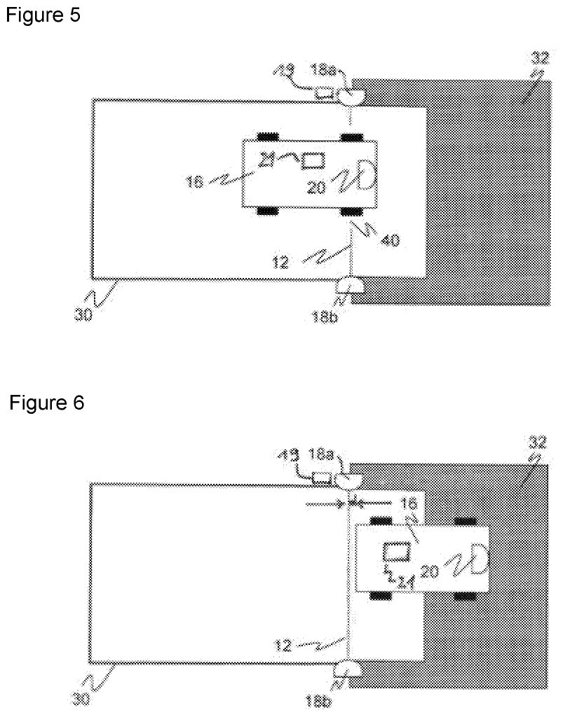

FIG. 5 a schematic plan view of the loading zone in which the driving-in loading vehicle is located in a drive-through corridor through the safeguarded access zone;

FIG. 6 a schematic plan view of the loading zone after the loading vehicle has driven into a second predefined position during the driving out;

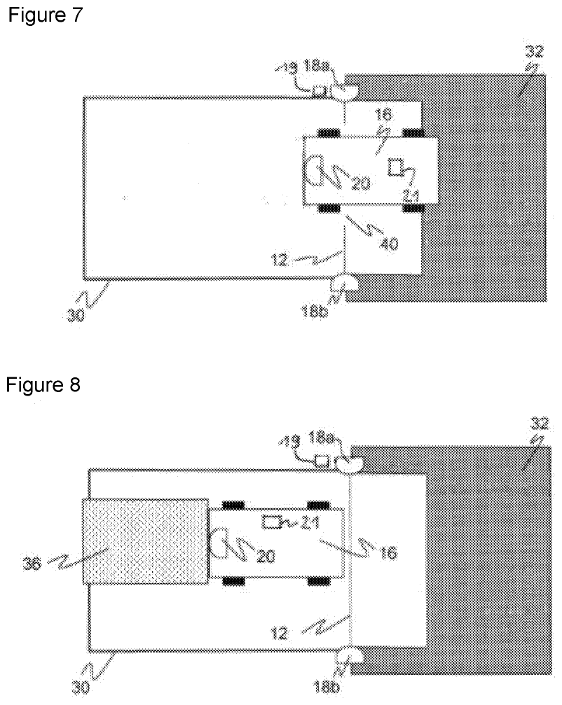

FIG. 7 a schematic plan view of the loading zone in which the driving-out loading vehicle is located in the drive-through corridor through the safeguarded access zone; and

FIG. 8 a schematic plan view of the loading zone in which the driving-out loading vehicle has passed through the access zone and the drive-through corridor has closed again.

FIG. 1 shows a schematic overview representation of a safeguarding system for safeguarding a loading and/or unloading of a loading space using a stationary sensor device 10 of an access zone 12 and a mobile sensor arrangement 14 of a loading vehicle 16. The loading vehicle 16 is preferably an autonomous vehicle such as an AGV or an AMR and is able to pick up and place load objects and thus to convey them from one location to another location.

The stationary sensor device 10 has at least one sensor, preferably a safe sensor 18a-b, wherein a respective two sensors 18a-b are used by way of example at both sides of the access zone 12 in the Figures. The mobile sensor arrangement 14 likewise has at least one sensor, preferably a safe sensor 20, wherein only one sensor 20 is provided by way of example in the Figures, but at least one further sensor can be added for a redundant, a rear and/or a side monitoring. The sensors 18a-b and 20 work in accordance with an electrosensitive sensor principle, preferably in accordance with an optical sensor principle as with a light grid, a laser scanner, a LiDAR sensor, a camera, or a 3D camera, in particular a time of flight camera or TOF camera, but also in accordance with non-optical sensor principles as with a radar or a radio location system, in particular UWB. The sensors 18a-b and 20 can be selected as desired from the named sensors and from further electrosensitive sensors, wherein some sensors are not equally suitable for the stationary sensor device 10 and the mobile sensor arrangement 14, for example, a light grid only for the stationary sensor device 10. The invention is described below by way of example using laser scanners for the mobile sensor arrangement and TOF cameras for the stationary sensor arrangement. In this respect, the object recognition is based on a protective field concept; this is also by way of example since it is only a matter of detecting objects and/or persons in the access zone 12 or in the respective travel path of the loading vehicle 16 in a safe manner.

A control and evaluation unit 22, 24 is provided in the stationary sensor device 10 and the mobile sensor arrangement 14 in each case. The control and evaluation functionality with the method subsequently described can practically be distributed as desired over the two control and evaluation units 22, 24 and also over at least one external control and evaluation unit of a higher-ranking system. However, at least the respective object detection or protective field evaluation preferably takes place close to or in the associated sensor 18a-b, 20. Any desired processing units can be considered as the hardware of the control and evaluation unit 22, 24; for instance, digital processing modules such as a microprocessor or a CPU (central processing unit), an FPGA (field programmable gate array), a DSP (digital signal processor), an ASIC (application specific integrated circuit), an AI processor, an NPU (neural processing unit), a GPU (graphics processing unit) or the like. An external processing unit can be a computer of any desired kind, including notebooks, smartphones, tablets, a (safety) controller, equally a local network, an edge device, or a cloud. Safety-relevant parts of the control and evaluation are preferably executed on safe hardware or reach a required safety level by other measures such as redundancy or tests. A signal processing according to the invention, implemented in the control and evaluation units 22, 24, is preferably designed as safe in a manner customary in the art, for example, by a suitable use of redundancy, for example according to Safety Integrity Level, SIL1, SIL2 or SIL3.

Furthermore, a communication interface 26, 28 is provided in the stationary sensor device 10 and in the mobile sensor arrangement 14 in each case. Furthermore, the stationary sensor device 10 and the mobile sensor arrangement 14 are preferably wirelessly connected to one another to exchange data, information and control signals. The communication connections can be implemented via any desired wireless communication connection according to standards such as Bluetooth, WLAN, WiFi, 3G/4G/5G, and in principle any other protocol.

The stationary sensor device 10 implements the safety function of access safeguarding. It is therefore recognized if an object is present in the access zone 12 and in particular if a person attempts to run through it. There is the possibility here of keeping certain parts of the safeguarded access zone 12 free in order to thus provide a drive-through corridor in which the safety function is bridged or muted. This can also be implemented by switching over to a protective field having a free zone.

The stationary sensor device 10 furthermore comprises an identity sensor 19. Said identity sensor is coupled to the control and evaluation unit 22. The identity sensor 19 is designed by way of example here as an RFID reader 19. The mobile sensor arrangement 14 is configured to provide a first piece of identity information. For this purpose, the mobile sensor arrangement 14 in the embodiment example shown comprises a transponder 21 that is here by way of exampled designed as an RFID transponder 21 and is coupled to the control and evaluation unit 24. Transponders 21 and readers 19 cooperate in the secure identification according to the invention of the loading vehicle 14 during the driving into the loading space 32.

The mobile sensor arrangement 14 implements the safety function of collision avoidance of the loading vehicle 16. Safety distances are thereby observed and objects or persons do not come into direct contact with the loading vehicle 16 or at most come into a non-consequential contact in the case of a minimal, safe speed of the loading vehicle 16.

If an unauthorized object is detected in the access zone 12 or in front of the loading vehicle 16, this triggers a safety response of the loading vehicle 16 to avoid dangers to persons. The mobile sensor arrangement 14 reacts to an object in front of the loading vehicle 16 in a safety-directed manner as part of its own collision avoidance. A safety-relevant situation due to an object in the access zone 12 when the loading vehicle is between the first position and the second position is reported to the mobile sensor arrangement 14 by the stationary sensor device 10 via the communication interfaces 26, 28. As the respective safety response, the loading vehicle 16 is stopped, carries out an evasive movement or reduces its speed such that a collision with a person becomes extremely unlikely and can at least not seriously endanger his health. The safety response can differ depending on whether it has been triggered by the collision avoidance or the access safeguarding.

A localization system of the loading vehicle 16 is preferably furthermore implemented by the mobile sensor arrangement 14 and/or a further sensor system, not shown. For this purpose, a map can additionally be stored in the control and evaluation unit 24. It is also possible to attach optical or physical markers in the environment of the loading/unloading zone. Using the localization system, the loading vehicle 16 in particular recognizes that it is in a safety-relevant zone and no longer, for example, in a blocked logistics zone inaccessible to persons so that the mobile sensor arrangement 14 has to be switched active. Thus, specific relevant first and second predefined positions, still to be described, can moreover be recognized during the loading/unloading.

FIG. 1 shows a stationary sensor device 10 in a 1:1 association with a mobile sensor arrangement 14. This is an exemplary simplification. One or more stationary sensor devices 10 having one or more mobile sensor arrangements 14 can work together or corresponding connections can be established or released depending on the location and the task of the loading vehicle 16.

FIG. 2 shows a schematic plan view of a loading zone or of a loading/unloading zone. The loading zone comprises a loading dock 30 and a loading space 32 of which only the front part is shown. The loading dock 30 forms a safety-relevant zone (“confined zone”) because persons may dwell here. To avoid possible dangers to the persons, the loading vehicle 16 therefore has to activate its mobile sensor arrangement 14 that is here shown in simplified form and as representative only by a laser scanner as the sensor 20. FIG. 2 shows some possible dangers due to a person 34a on the loading dock 30, a person 34b in the loading space 32, or a laterally located person 34c-d whose arm could in particular be crushed. The mobile sensor arrangement 14 is indeed capable of recognizing all these persons 34a-d in good time and of initiating a corresponding safety response. The problem is that, due to the tightly packed and unknown load objects, a decision can above all practically not be made within the loading space 32 as to whether a person 34b is there. The loading vehicle 16 has to initiate its safety response as a precaution and is thus practically not available. On the other hand, the mobile sensor arrangement 14 cannot be simply deactivated because the safety in the shown positions and in further positions of persons 34a-d would then not be ensured.

The method according to the invention for loading or unloading the loading space 32 will now be explained with reference to FIGS. 3 to 8. All the described steps of the particularly preferred overall concept do not necessarily have to be carried out here. The loading space 32 is by way of example the trailer of a truck. The invention can, however, also be used for a different loading space 32 having a different ante-zone than the loading dock 30.

FIG. 3 shows a schematic plan view of the loading zone with a loading dock 30 and a loading space 32 on an approach of a loading vehicle 16 driving in. The loading space 32 is closed at all sides, with the exception of the access zone 12 via which the loading space 32 can be driven to from the loading dock 30. The stationary sensor device monitors the access zone 12 so that no object and no person moves into the loading space 32 unnoticed. Of the stationary sensor device 10, only two oppositely arranged laser scanners are shown as sensors 18a and 18b in a simplified and representative form here; the mobile sensor arrangement of the loading vehicle 16 is still represented by the sensor 20 that monitors a protective field 36 in the direction of travel outside the loading space 32.

At the start of a loading/unloading procedure, the trailer having the loading space 32 is docked at the loading dock and the driver of the truck or a member of the logistics staff opens the trailer and thus makes the loading space 32 accessible via the access zone 12. This is followed by a manual check that no person is in the loading space 32 by a visual check or by calling and the like. The stationary sensor device 10 is then switched active via a button, for example. Such a manual release procedure or (re-)start procedure for the putting into operation is typical for technical safety applications. After the activation, the stationary sensor device 10 ensures that no access takes place and the loading space 32 remains free of persons.

When the loading vehicle 16 approaches the loading dock 30, it preferably recognizes by means of its localization system that it is now in a safety-related zone and at the latest then activates the protective field 14 using its mobile sensor arrangement 14. Alternatively, the protective field 36 may always be active while the loading vehicle 16 is moving, with the exception of movements that take place after the first predefined position has been reached and the vehicle 16 has been identified, i.e. in particular movements in the loading space 32. The loading vehicle 16 or its mobile sensor arrangement 14 establishes a communication connection with the stationary sensor device 10. It queries, for example, whether the access safeguarding is ready for operation, i.e. if no access has previously taken place and accordingly no person can be present in the loading space 32. The protective field 36 can, as indicated by the arrow 38, be successively shortened during the approach of the loading vehicle 16 to the safeguarded access zone 12. A monitoring into the loading space 32 is not necessary since the stationary sensor device 10 prevents access so that a protective field 36 projecting into the loading space 32 anyway cannot detect any person, but a false triggering of the safety response by an object in the loading space 32 is still very much possible.

FIG. 4 shows a schematic plan view of the loading zone in which the loading vehicle 16 driving in has reached a first predefined position close to the safeguarded access zone 12. In the first predefined position, the distance d between the loading vehicle 16 and the safeguarded access zone 12 is no longer sufficient that a person 34, indicated hatched, would fit therebetween. The distance d is, for example, 20 cm or even less, but even with a somewhat larger distance d such as 30 cm, 50 cm, or 70 cm, a person will not be able to push between the loading vehicle 16 and the safeguarded access zone 12 without being noticed by the stationary sensor device. The loading vehicle 16 in particular recognizes the reaching of the first position via its safe localization system.

The reaching of the first predefined position marks the point in time for the safe identification according to the invention of the loading vehicle 16. In this respect, in the example described here, the ID stored on the transponder 21 is transmitted to the reader 19 as the first piece of identity information in accordance with the standard RFID method. The ID read out is checked in the control and evaluation unit of the stationary sensor device, for example by comparing it with an identity stored there and second piece of identity information. The second piece of identity information can be, for example, the MAC address of the communication interface 28 from FIG. 1, or an address on the application layer of the protocol, which was transmitted to the stationary sensor device, in particular its communication interface 26 from FIG. 1, during the registration. If the loading vehicle can be successfully identified in this way, it may drive into the loading space 32.

The stationary sensor device creates a drive-through corridor for this purpose. A corresponding section of the safeguarded access zone 12 is muted or a switch is made to a protective field configuration that releases the drive-through corridor. The stationary sensor device then instructs the mobile sensor arrangement to deactivate the collision avoidance and continue driving. It is ensured that there is no person in front of the loading vehicle 16 and thus in the loading space 32 behind the safeguarded access zone 12.

FIG. 5 shows a schematic plan view of the loading zone in which the loading vehicle 16 driving in is located in the released or muted drive-through corridor 40 of the safeguarded access zone 12. Laterally, i.e. in a dimension transversely to the direction of travel, the location of the drive-through corridor 40 is either dynamically adapted to the lateral position of the loading vehicle 16 or the loading vehicle 16 is driven into a position with a fixed lateral position so that the lateral position of a fixed drive-through corridor 40 matches the lateral position of the loading vehicle 16. The direction of travel in the Figures is from left to right by way of example on the driving in; accordingly, the lateral position corresponds to the vertical location in the representation. During the driving through, an exchange of signals preferably takes place between the mobile sensor arrangement 14 and the stationary sensor device 10 to keep the drive-through corridor 40 open.

When the loading vehicle 16 has completely traveled over the access zone 12, the drive-through corridor 40 is closed again. The loading vehicle 16 can then move freely in the loading space 32 with a still inactive collision avoidance and can transport load objects there, in particular can place down its taken-along load or can pick up a new load.

FIG. 6 shows a schematic plan view of the loading zone after the loading vehicle 16 has placed or picked up a load object in the loading space 32 and is in the process of leaving the loading space 32 again while moving forwards or backwards. The loading vehicle 16 has already moved forward into a second predefined position that is located within the loading space 32 at a distance d so close to the safeguarded access zone 12 that no person fits between the loading vehicle 16 and the access zone 12. The drive-through corridor 40 is still closed. With the aid of the localization system of the loading vehicle 16 and the transmission of the determined position to the stationary sensor device, on the one hand, and the distance measurement by the stationary sensor device, on the other hand, the stationary sensor device recognizes that the loading vehicle 16 is actually at the required position, namely the second predefined position. The stationary sensor device then initiates the re-creation of a drive-through corridor by a regional muting of its safeguarding.

FIG. 7 shows a schematic plan view of the loading zone in which the loading vehicle 16 driving out is located in the drive-through corridor 40 through the safeguarded access zone 12. During the driving through, an exchange of signals again preferably takes place between the mobile sensor arrangement and the stationary sensor device to keep the drive-through corridor 40 open.

FIG. 8 shows a schematic plan view of the loading zone in which the loading vehicle 16 driving out has completely passed through the access zone 12. The access zone 12 is closed again. As soon as this has taken place, the stationary sensor device again safeguards the access zone 12 against an entry by persons. The mobile sensor arrangement 14 now at the latest switches its collision protection or the protective field 36 active again since a person may be present in front of the safeguarded access zone 12. The activation can also already take place a little earlier depending on the speed at which the loading vehicle 16 moves. The loading vehicle 16 can then again continue to move on the loading dock 30 under the sole responsibility of its mobile sensor arrangement and can, for example, collect the next load object or can place down a load object taken along from the loading space 32 at a location provided for this purpose, for example, at the margin of the loading dock 30 or in a logistics hall.

As long as the drive-through corridor 40 is open, and this applies on the driving out as already before on the driving in, the loading vehicle 16 physically prevents an unnoticed entry of a person, who would inevitably be noticed by the non-muted portion of the safeguarded access zone 12, due to the dimensions of the drive-through corridor 40 adapted to the loading vehicle 16 and due to the first position and second position disposed close to the safeguarded access zone 12.

If the stationary sensor device 10 recognizes an object in the safeguarded access zone 12 at any point in time, the loading vehicle 16 may no longer drive into the loading space 32 until the stationary sensor device 10 has again been released, which as a rule requires a manual check of the loading space 32. Under certain circumstances, the stationary sensor device 10 can still differentiate a direction of movement and can nevertheless still tolerate an object partially moving in, but then moving out again. An object only moving out indicates that the initial release was defective; that may therefore not occur and a general appraisal should take place here as required. If the loading vehicle 16 is already in the loading space 32 when the safeguarded access zone is infringed, the loading vehicle 16 has to stop or has to depart from the loading space 32 at a very slow safe speed or with an active collision avoidance function.

### REFERENCE NUMERAL LIST

16 loading vehicle
18a, 18b, 20 sensor
14 mobile sensor arrangement
10 stationary sensor device
26, 28 communication device
22, 24 control
21 transponder
30 loading dock
12 access zone
32 loading space
34, 34a, 34b, 34c, 34d person
36 protective field
38 arrow
19 identity sensor
40 drive-through corridor

1. A method for loading and/or unloading a loading space using an autonomous loading vehicle that drives into the loading space at least once in order to pick up and/or place at least one load object, wherein an access zone of the loading space is safeguarded by a stationary sensor device arranged at the access zone, wherein the loading vehicle is safeguarded by a mobile sensor arrangement arranged at the loading vehicle,
wherein the stationary sensor device and the mobile sensor arrangement communicate with one another, and wherein, before a driving into the loading space, the loading vehicle is uniquely identified by the stationary sensor device using an identification sensor included by the stationary sensor device and at least a first piece of identity information provided by the mobile sensor arrangement.

2. The method according to claim 1,
wherein a point in time at which the loading vehicle is uniquely identified is determined using a first reliable position determination.

3. The method according to claim 2,
wherein the first safe position determination comprises at least one running through of the following steps:
detecting a distance of the loading vehicle from the access zone by means of the stationary sensor device,
determining a position of the loading vehicle by means of its mobile sensor arrangement and transmitting this position to the stationary sensor device, validating the transmitted position of the loading vehicle with the detected distance by means of the stationary sensor device, and
if the validated position corresponds to a predefined first position, starting the unique identification of the loading vehicle by the stationary sensor device,
wherein the predefined first position is located outside the loading space so close to the access zone that no person fits between the loading vehicle and the access zone.

4. The method according to claim 3,
wherein the determination of the position of the loading vehicle by its mobile sensor arrangement takes place using a localization system on the basis of one or more of the following measures:
a map stored in the mobile sensor arrangement,
a recognition of optical or physical markers that are attached in the access zone,
an indoor navigation.

5. The method according to claim 1,
wherein the following steps are carried out when uniquely identifying the loading vehicle:
contactlessly reading the first piece of identity information provided by the mobile sensor arrangement by means of the identity sensor of the stationary sensor device,
checking the first piece of identity information by means of the stationary sensor device using a stored identity and a second piece of identity information that is transmitted by the mobile sensor device and that is different from the first piece of identity information.

6. The method according to claim 5,
wherein the contactless reading of the first piece of identity information provided by the mobile sensor arrangement takes place using one of the following means: radio frequency identification, optical readout, short-range radio communication, and wherein the provided first piece of identity information accordingly comprises one of the following: a radio frequency identification transponder ID, a barcode, a QR code, a short-range radio communication transponder ID.

7. The method according to claim 5,
wherein the transmission of the second piece of identity information of the mobile sensor arrangement to the stationary sensor device takes place via a wireless communication device, and wherein the second piece of identity information is accordingly a device identifier, or an application-specific identifier.

8. The method according to claim 1,
wherein, after a successful unique identification of the loading vehicle, the safeguarding of the access zone by the stationary sensor device is adjusted such that a drive-through corridor is provided for a driving of the loading vehicle into the loading space, and the safeguarding of the mobile sensor arrangement is deactivated,
wherein the drive-through corridor is closed as soon as the loading vehicle has passed through the access zone and wherein the stationary sensor device safeguards the access zone from this point in time by recognizing access by an object.

9. The method according to claim 1,
wherein a communication between the stationary sensor device and the mobile sensor arrangement takes place using a wireless communication device.

10. The method according to claim 1,
wherein, on a driving of the loading vehicle out of the loading space, a point in time at which a drive-through corridor is provided for the passing through of the access zone by the loading vehicle by adjusting the safeguarding by the stationary sensor device is determined using a second safe position determination,
wherein the drive-through corridor is closed as soon as the loading vehicle has passed through the access zone, and wherein the stationary sensor device safeguards the access zone from this point in time by recognizing access by an object, and the mobile sensor arrangement safeguards the loading vehicle against collision.

11. The method according to claim 10,
wherein the second safe position determination comprises at least one running through of the following steps:
detecting a distance of the loading vehicle from the access zone by means of the stationary sensor device,
determining a position of the loading vehicle by means of its mobile sensor arrangement and transmitting this position to the stationary sensor device, validating the transmitted position of the loading vehicle with the detected distance by means of the stationary sensor device, and
if the validated position corresponds to a predefined second position, providing the drive-through corridor,
wherein the predefined second position is located within the loading space so close to the access zone that no person fits between the loading vehicle and the access zone.

12. The method according to claim 11,
wherein the determination of the position of the loading vehicle by its mobile sensor arrangement takes place using a safe localization system.

13. The method according to claim 1,
wherein, when the presence of an object in the access zone is recognized by the stationary sensor device, a safety response of the loading vehicle is initiated in which the loading vehicle is stopped, or performs an evasive movement or reduces its speed.

14. A safeguarding system for safeguarding a loading and/or unloading of a loading space using an autonomous loading vehicle that drives into the loading space at least once in order to pick up and/or place at least one load object,
wherein the safeguarding system has a stationary sensor device arranged at an access zone of the loading space and a mobile sensor arrangement arranged at the loading vehicle,
wherein the stationary sensor device is configured to safeguard the access zone of the loading space and has at least a first sensor that is arranged at the access zone, an identification sensor and a communication interface for communicating with the mobile sensor arrangement,
wherein the mobile sensor arrangement is configured to safeguard the loading vehicle and to provide at least a first piece of identity information and has at least a second sensor and a communication interface for communicating with the mobile sensor arrangement,
wherein the stationary sensor device is configured to uniquely identify the loading vehicle before a driving into the loading space using the identification sensor and at least the first piece of identity information.

15. The safeguarding system according to claim 14,
wherein the first sensor and/or the second sensor is/are one of the following: a single layer laser scanner or a multilayer laser scanner, a LiDAR sensor, a 3D camera, a radar sensor or a radio location system,
wherein the identification sensor is one of the following: a reading device for radio frequency identification, an optical scanner for barcodes or QR codes, or a short-range radio communication base station.

16. The method according to claim 1,
wherein the loading space is the loading space of a transport vehicle.

17. The method according to claim 3,
wherein the step of validating the transmitted position of the loading vehicle takes place using a tracking algorithm.

18. The method according to claim 7,
wherein the wireless communication device is a wireless local area network.

19. The method according to claim 9,
wherein the wireless communication device is a wireless local area network.

20. The method according to claim 11,
wherein the step of validating the transmitted position of the loading vehicle takes place using a tracking algorithm.
